(19) United States
(12) Patent Application Publication
(10) Pub. No.: US 2005/0130542 A1
(43) Pub. Date: Jun. 16, 2005

(54) Flexible fluid-tight web

(76) Inventor: Hans Georg Klein, Wehrheim (DE)

Correspondence Address: REED SMITH LLP, 3110 FAIRVIEW PARK DRIVE, SUITE 1400, FALLS CHURCH, VA, 22042, US

(21) Appl. No.: 10/498,941

(22) PCT Filed: Dec. 17, 2002
(86) PCT No.: PCT/EP02/14352

(30) Foreign Application Priority Data
Dec. 17, 2001 (DE) 201 20 392.8

(51) Int. Cl. B32B 27/04; B32B 5/02; B32B 27/12

(52) U.S. Cl. 442/394; 442/86; 442/417; 442/401; 442/402; 442/403; 442/340; 442/382

(57) ABSTRACT

A flexible fluid-tight material web, particularly for protective clothing or personal care articles, out of a two or multi-layer composite comprising a porous sheet backing, for example a carrier fleece, where a fluid-tight layer is arranged on the backing, characterized in that the fluid-tight layer is a hot melt adhesive film applied in hot condition to the backing. A method of producing a highly absorbent flexible material web of two or more composite layers, the material web comprising a porous sheet backing, a fluid-tight layer being arranged on the backing, comprising the method steps of: applying a hot melt film onto the porous backing; powdering super absorber polymer powder directly onto the still hot melt of the hot melt film; applying a cover layer to the hot melt film and super absorber polymer powder; and bonding the layers by calandering.

The invention relates to a multilayer, fluid-tight material web, particularly for protective clothing and personal care articles as set forth in the preamble of claim 1. The invention relates furthermore to a method of producing a flexible material web as set forth in claim 18.

Materials of the aforementioned kind find application, for example, but not at all exclusively, as function materials in the production of special work clothing for protection from chemicals or for use in clean-room environments, in the production of rainwear as well as function materials, as backsheets for personal care articles, such as diapers, for example. Such materials comprise a fluid-tight layer which has the task of preventing the ingress of foreign substances, soilage, chemicals and other fluids, in particular water.

Where these materials relates to industrial health and safety clothing, the materials are classified in accordance with European Standard requirements. Classes 5 and 6 mainly involve single or multilayer microfiber fleeces, whereas classes 3 and 4 relating to protection from fluid chemicals and other critical fluids involve fabrics or fleeces engineered with various coatings (e.g. PVC).

One drawback of such coatings is firstly experienced in that they particularly lack permeability to water vapor. Where this involves, for example, industrial health and safety clothing it results in highly uncomfortable sweat trapping.

Backsheets in personal care articles, in other words diapers or incontinence pads are, as a rule, two-layer composites of PE films impermeable or permeable to vapor made of PP spun-bond or staple fiber fleeces. These serve as a fluid barrier and in conjunction with further absorbent material layers, for example, with a super absorber polymer (SAP), also as a fluid retainer. The trend is since in the direction of products open to water vapor in substantially enhancing wearing comfort.

For this purpose, microporous films of PE find application in backsheets as known from prior art. The drawback here, however, is that the desired textile character, for instance its soft feel at the surface of the material is significantly detrimented. It is particularly the microporous films known from prior art and engineered with a high filler proportion (CaCO₃) for permeability to water vapor that exhibit this drawback.

Function materials for sports and all-weather clothing, especially waterproof materials open to diffusion or permeable to water vapor are based on complex, and thus expensive multilayer materials need to be fabricated and assembled in several procedures.

It is against this background that the object of the present invention is to provide a multilayer fluid-tight material web for overcoming the cited drawbacks and which permits cost-effective production, it being especially the intention to produce multilayer composites featuring particular good textile properties compatible for use.

This object is achieved by a material web having the features as set forth in claim 1 and by a method having the features as set forth in claim 18 for producing such a material web.

Preferred embodiments are the subject matter of the sub-claims.

The material web in accordance with the present invention is firstly structured as a two or multilayer composite known as such, the multilayer composite comprising a porous sheet backing, for example a backing material or backing fleece as well as fluid-tight layer disposed on the backing.

In accordance with the invention the fluid-tight layer in the material web is not provided, as known from prior art, as a film, film coating or as a separate membrane, it instead constituting a hot melt adhesive film directly applied to the backing and acting as a membrane. Now, because of the hot melt adhesive film directly applied to the porous backing, there is no need for the membrane or film, as formerly necessary, without sacrificing the fluid impermeable function of the material web.

Since the hot melt adhesive film can be maintained extremely thin, it has practically no influence on, or change in, the strength properties as well as the look and feel of the backing material, this, on the one hand, serving optimum processing in the production of textiles or personal care articles, whilst on the other, substantially enhancing the wearing comfort of such textiles or personal care articles. On top of this, coating the backing material with the hot melt adhesive is done hot, resulting in a full-surface, intimate keying of the hot melt adhesive film to the backing material.

In accordance with a particularly preferred example embodiment of the invention the hot melt adhesive constituting the fluid-tight layer of the material web is diffusion-open, i.e. breathable. Now, coating the backing material with the hot melt adhesive film results in a material web which although, on the one hand, reliably prevents ingress and penetration of fluids and water, permits, on the other, wicking of bodily moisture and discharge thereof to the ambient air.

Tests have demonstrated that material webs having optimum strength properties and optimum impermeability to water, for example, are now attained when, as provided for in a further preferred embodiment of the invention ethylene vinyl acetates, polyamides, polyvinyl alcohols or polyurethanes are employed as the material for the hot melt adhesive film. In accordance with another embodiment the material for the hot melt adhesive film comprises hydrophilic components and a surface tension associated therewith of≦20 mN/m.

The hydrophilic components ensure that the hot melt adhesive film receives the desired properties for the passage of water molecules, i.e. moisture vapor, whilst, however, retaining the impermeability to fluids. Tests have shown that material webs having particular advantageous properties can now be created when for the hydrophilic components of the hot melt adhesive film, elastomers based on polytetramethylene oxide, comonomers of polypropylene oxide and polyethylene oxide or hydrophilic polymer plasticizer, are put to use, the latter excelling by being especially cost-effective.

A further advantage of the invention results from fluid-tight layers that can now be produced in practically any thickness because of coating the backing material with a hot melt adhesive as the principle in forming a fluid-tight layer. Preferably the coating weight of the hot melt adhesive is, however, in the range 5 to 50 g/m² depending on the particular application.

The backing materials involved are preferably porous, air permeable, sheet backings, for example, fleeces. As is particularly preferred, the backing layers are provided in the form of polypropylene, polyethylene terephthalate or polyethylene spun-bond, staple or microfiber (meltblown) fleeces.

It has been surprisingly discovered that after lamination with the hot melt adhesive film a permeability to water vapor better than 200 g/m²×d is still attainable. In this arrangement the weight of the backing is preferably in the range 10 to 150 g/m², when employing spunbond fleece of polypropylene or low or high density polyethylene preferably in the range 10 to 60 g/m².

Another special advantage afforded by the fluid-tight layer formed in accordance with the invention by a hot melt adhesive film is that the resulting fluid-tight layer not only enters into an intimate connection with the base material but can also be made use of for laminating or bonding with further layers of material. It is against this background that it is provided for in accordance with a further embodiment of the invention that a cover layer is disposed additionally on the hot melt adhesive film, this cover layer being, for example, a single-layer of a cover fleece or, however, also a multilayer cover.

In accordance with yet another further embodiment of the invention the cover fleece or surface of a multilayer composite disposed on the hot melt adhesive film may be additionally engineered particular kind to the skin by oily or fatty avivages. This is particularly of advantage for personal care articles involving direct skin contact.

To enhance the structural integrity and strength of the material composite particular where large surface products are involved, such as, for example, incontinence pads but also where particularly high strength is required, it is provided for in still another embodiment of the invention that a strengthening fabric or strengthening mesh is arranged in or on the hot melt adhesive film. Embedding or keying these in/to the hot melt adhesive film achieves especially good handling of the forces stressing the composite.

In accordance with still another embodiment of the invention the material web is characterized by it comprising embedded in the hot melt adhesive or arranged on the surface of the hot melt adhesive a powdery super absorber polymer (SAP), for example on the basis of a gel-forming polyacrylic acid ester. This now makes it possible to create particularly highly absorbent composite materials for personal care articles both simply, reliably and cost-effectively. In this arrangement the special advantage afforded by the super absorber polymer powder being embedded in or keyed to the hot melt adhesive is that the material composite retains its structural integrity even after having absorbed large amounts of fluid, there being practically no “bleeding” of the SAP gel even when the cover layer is damaged.

It is particularly in personal care articles, such as for example diapers, where an extremely high wicking capacity is of major importance that covering or enveloping the super absorber polymer with a hydrophilic microfiber fleece, particular with a meltblown is of advantage in still another preferred embodiment of the invention. On coming into contact with fluid the hydrophilic microfiber fleece directly interfacing the SAP powder ensures instant blotting of the wicked fluid over a large surface area, because of its high wicking capacity, resulting in a large surface area of the SAP powder being wetted or activated.

In accordance with still another preferred embodiment of the invention the super absorber polymer is covered by a composite of a layer of hydrophilic spunbond fleece, for example of polypropylene or polyethylene, having a weight preferably in the range 8 to 50 g/m² and a layer of a hydrophilic meltblown, for example polypropylene, having a weight preferably in the range 10 to 100 g/m². In this arrangement, as described above, the melt blown directly interfacing the SAP powder in turn ensures rapid, full-surface blotting of the ingress fluid. The spunbond fleece cover layer keyed to the meltblown satisfies particularly both strength, look and feel requirements whilst being particularly suitable for direct skin contact.

Instead of the meltblown layer a textile flaking may be employed, applied either to the hot melt film or to the SAP powder, or, however, to the rear side of the hydrophilic spunbond fleece. Employing a textile flaking is particular of advantage with a view to speeding up production due to the more intimate keying of the hot melt film with the super absorber polymer whilst making for no problems in being coated even on an irregular or creviced surface.

It is particularly of advantage furthermore when the hot melt adhesive film is urged into the interspaces of the creviced backing fleece or allowed to sink therein when coating the backing layer therewith. The resulting increase in the surface area with a simultaneous reduction in the thickness of the hot melt adhesive film produces a substantial increase in the wicking surface area, this now making it possible to boost the permeability to water vapor of the composite material configured as such by a further factor of three to five to then be better than 200 g/m²×d at 23° C. and 0%./.85%.

Another advantage of the hot melt adhesive sinking down into the cavities of the backing fleece is that the individual fibers thereof are interbonded, substantially enhancing the structural integrity of the backing and thus also of the composite as a whole.

The hot melt adhesive film may also be disposed, for example, between two backing materials permeable to water and vapor, e.g. textile fleeces, one of which is the backing whilst the other is the cover fleece.

The invention relates furthermore to a method of producing a highly absorbent material web comprising a porous sheet backing and a fluid-tight layer arranged on the backing layer. The method in accordance with the invention comprises the steps as described in the following.

Firstly, step a) of the method involves coating the porous backing layer with a hot melt film, and then in step b) powdering the melt of the latter with super absorber polymer powder directly whilst still hot.

The following step of the method c) involves covering the hot melt film and super absorber polymer powder with a cover layer, before, in conclusion in step d) bonding the layers of the material web together by calandering.

The method in accordance with the invention now makes it possible to produce highly absorbent multilayer material webs particularly cost-effective whilst achieving exceptionally high quality and structural integrity of the material webs produced thereby. The reason for this is particularly that the hot melt film in the method in accordance with the invention is capable of satisfying several totally different functions at the same time.

Thus, for one thing, the hot melt film forms a fluid barrier in now making it possible to use microfiber fleeces particularly kind to the skin and with a good look and feel for the backing layer, instead of plastics films. For another, the hot melt film serves to anchor the super absorber polymer powder spread which, as compared to prior art, now results in composites of particularly high structural integrity and strength whilst being safe from “bleeding” even when having absorbed large amounts of fluid and substantially maintaining their shape even when the material is damaged. In conclusion, the hot melt film also satisfies the requirements of keying the individual material layers together, the penetration of the hot melt adhesive between the fibers in the surface of the individual material layers further enhancing the structural integrity of the composite.

In accordance with a preferred embodiment of the method in accordance with the invention the cover layer applied in step c) of the method is a composite of a spunbond fleece and a meltblown (SM composite). This now achieves particularly highly absorbent material webs since the meltblown is capable of blotting ingress fluids very quickly over a large surface area because of its excellent capillary (wicking) effect, resulting in a major surface area of the super absorber polymer powder being wetted or activated. In this arrangement the spunbond fleece takes over the task of adding to the structural integrity and definition of the meltblown on the surface of the material.

Instead of engineering the cover layer in step c) of the method as a finished composite of meltblown and spunbond fleece, the meltblown may be replaced by a textile flaking applied before application of the spunbond fleece. In this arrangement, the textile flaking can be applied either to the hot melt film or super absorber polymer layer or, however, to the rear side of the spunbond fleece. This now makes it possible to set the absorbent properties of the composite material produced by suitably tweaking the parameters of the textile flaking without having to rejig the method to other types of material to be applied.

To further consolidate the individual material layers of the composite it is provided for in accordance with a further embodiment of the method in accordance with the invention to line the cover layer with a hot melt spray application immediately prior to applying the cover layer. This now makes it possible to further improve keying of the cover layer applied to the super absorber polymer layer, resulting in exceptionally high strength material composites.

The gist of the invention is not dictated by the way in which the method in accordance with the invention is translated in design or operation, i.e. it may be implemented discontinuously or off-line, although in accordance with a preferred embodiment of the invention steps a) to d) may be implemented continuously inline, i.e. on the fly. This now makes it possible to achieve a particular high throughput with good repeatability of the quality parameters of the material composite.

To obtain material composites of particular high strength performance it is provided for in accordance with a further embodiment of the invention to apply a strengthening fabric or strengthening mesh in and on the hot melt film resp. In this arrangement, the strengthening fabric or mesh enters into an intimate association with the melt of the hot melt film whilst still hot. This now makes it possible to introduce and distribute the forces into the material composite over a large surface area in producing material composites of extremely high loading capacity by the interaction of the strengthening and anchoring by the hot melt adhesive.

The invention will now be detailed by way of example aspects as illustrated in the drawings in which:

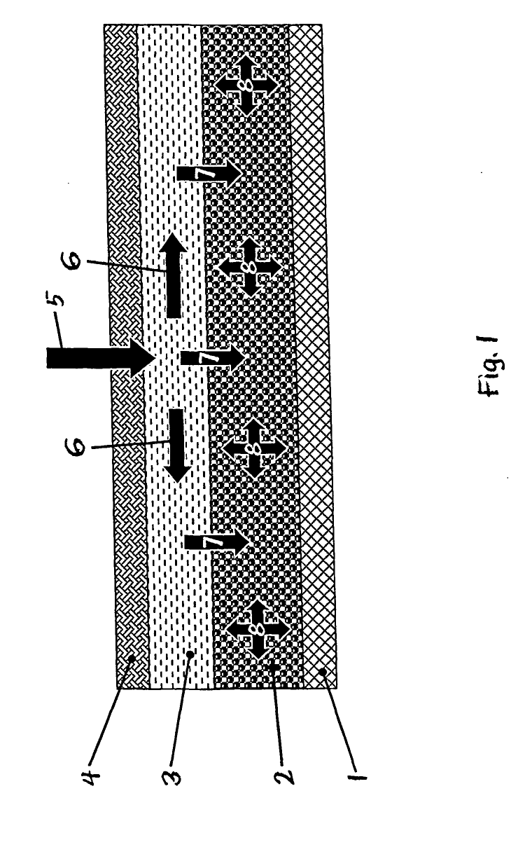

FIG. 1 is a diagrammatic side section view, not to scale, showing the principle functioning of a prior art fluid impermeable absorbent material composite:

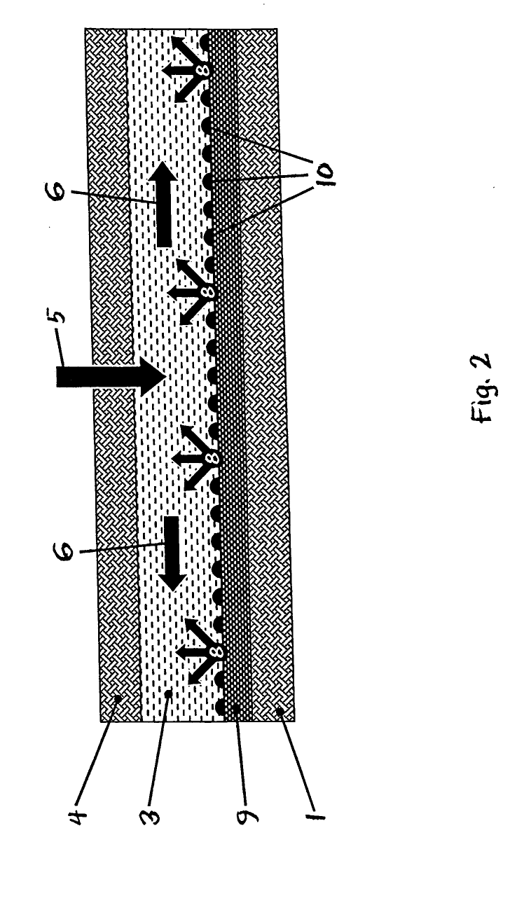

FIG. 2 is a view corresponding to that of FIG. 1 showing the functioning of a material composite in accordance with the present invention;

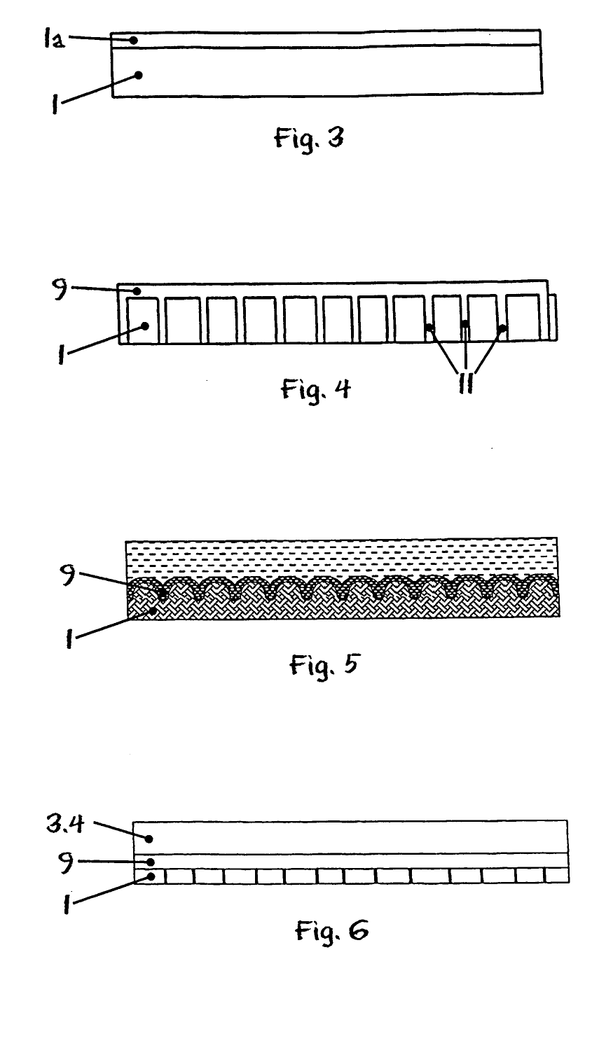

FIG. 3 is a view corresponding to that as shown in FIG. 1 and FIG. 2 showing the principle structure of a prior art fluid impermeable composite comprising backing layer and membrane;

FIG. 4 is a view corresponding to that as shown in FIG. 1 to FIG. 3 showing the principle structure of a fluid impermeable composite in accordance with the present invention;

FIG. 5 is a view corresponding to that as shown in FIGS. 1 to 5 showing the principle of increasing the surface area of the hot melt film in accordance with the invention.

FIG. 6 is a view corresponding to that as shown in FIGS. 1 to 4 showing an example aspect of a multilayer composite;

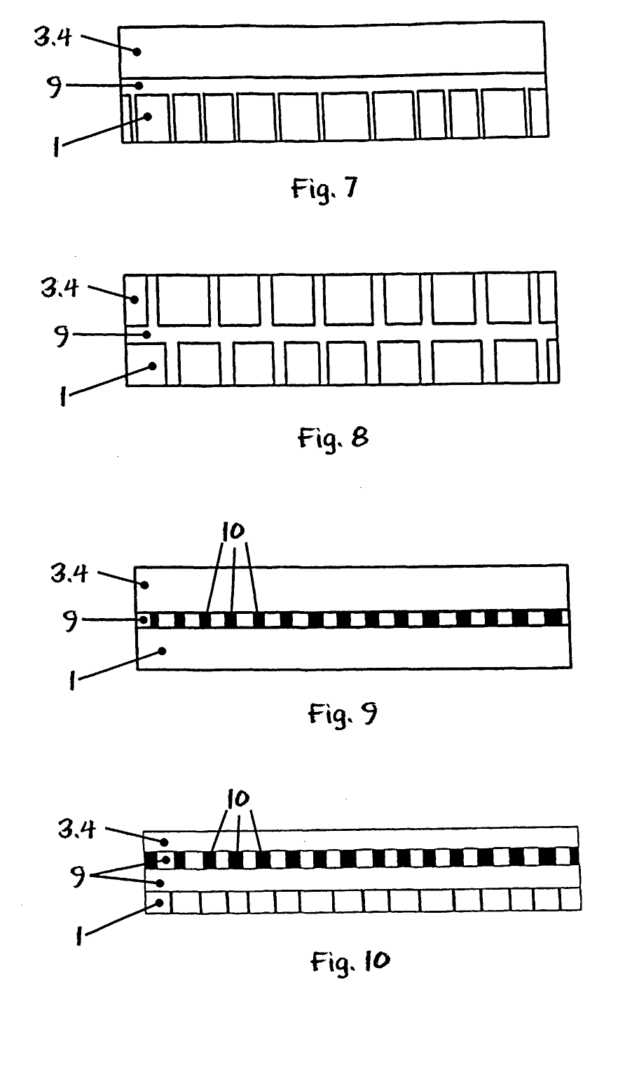

FIG. 7 is a view corresponding to that as shown in FIGS. 1 to 6 showing the membrane portion of the multilayer composite as shown in FIG. 6 on a magnified scale;

FIG. 8 is a view corresponding to that as shown in FIGS. 1 to 7 showing the principle of mutual anchoring of the various material layers in accordance with the invention;

FIG. 9 is a view corresponding to that as shown in FIGS. 1 to 8 showing the principle structure of a composite with embedded super absorber polymer; and

FIG. 10 is a view corresponding to that as shown in FIGS. 1 to 9 showing the structure of a composite powdered with a super absorber polymer.

Referring now to FIG. 1 there is illustrated diagrammatically a cross-section through a fluid impermeable absorbent material composite as known in principle from prior art.

Evident firstly is the backing layer 1 located at the bottom in the drawing which in accordance with prior art generally comprises a possibly microporous film of polyethylene. Arranged directly on the backing layer 1 is the absorbent core 2 comprising a highly absorbent material, for example, a layer of super absorber polymer material. Provided in turn above the absorbent layer 2 is a retaining layer 3 for rapidly absorbing the fluid wicked into the multilayer composite with blotting of the fluid within the plane of the multilayer composite. The retaining layer 3 generally comprises a staple fiber fleece or meltblown. Topping the material composite is the cover layer 4 which is generally provided in the form of a fluid permeable spunbond fleece.

Evident furthermore from FIG. 1 is the wicking principle in the material composite as well as the blotting and retaining of the fluid therein. The arrow identified by the reference numeral 5 stands for an amount of fluid applied to the cover layer 4 which due to the open-pore character of the cover layer 4 and the strong capillary or wicking effect of the retaining layer 3 is instantly wicked through the cover layer 4 and firstly held by the retaining layer 3. Likewise because of the strong wicking effect the fluid 5 is horizontally blotted within the surface area of the retaining layer 3, in relation to the drawing, as indicated by the arrows identified by the reference numeral 6.

Subsequent to the horizontal blotting 6 thereof the wicked fluid 5 is passed on from the retaining layer 3 to the absorbent layer 2 as indicated by the arrows identified by the reference numeral 7. Within the absorbent layer 2 the fluid 5 is ultimately gelled by activation, expansion and gelling of the super absorber polymer contained in the absorbent layer 2 as indicated by the arrows 8 standing for an expansion.

As cited at the outset, this prior art structure of absorbent multilayer composites has numerous drawbacks, but especially as cited again in the present context, deficient wearing comfort and look and feel of the polyethylene film 1 forming the backing layer, the complicated structure and particular the lack of coherence of the individual layers and deficient anchoring of the super absorber polymer within the absorbent layer 2.

Referring now to FIG. 2 there is illustrated how these drawbacks are eliminated by the multilayer composite as shown therein, embodying an aspect of the present invention. The multilayer composite as shown in FIG. 2 comprises likewise a backing layer 1. But unlike prior art the backing layer 1 as shown in FIG. 2, just like the cover layer 4, is provided in the form of an exceptionally air permeable fiber fleece which decisively improves the wearing comfort and look and feel of material composites structured as such.

In the material composite as shown in FIG. 2 the necessary fluid impermeability is assured by a fluid impermeable membrane 9 directly applied to the backing layer 1 which in accordance with the invention is provided in the form of a hot melt adhesive layer 9.

Applied directly to the hot melt film 9, in turn, is the super absorber polymer in the form of finely dispersed powder 10 associated particularly with the advantage that the super absorber polymer 10 is keyed or three-dimensionally anchored via the hot melt film 9 to the backing layer 1 as a major contribution towards enhancing structural integrity, preventing bleed and thus adding to the usefulness of a material composite structured as such.

Arranged, as shown in the drawing, above the hot melt film 9 or super absorber polymer 10 is again a retaining layer 3 serving for instant wicking and surface blotting 6 of the fluid 5 coming into contact with the material composite and which is subsequently trapped in the material composite as shown in FIG. 2 by activation, expansion and gelling of the super absorber polymer globules 10 as indicated by the arrows 8 depicting expansion of the super absorber polymer 10.

The cover layer of the material composite as shown in FIG. 2 may comprise to advantage an SM composite comprising a semi-finished product of spun blown fleece 4 and meltblown 3. In this context, a further decisive advantage of the material composite structured in accordance with the invention as shown in FIG. 2 is, as already described, the multi-function of the hot melt film 9. For, the hot melt film 9 now serves not only to create the fluid-tight layer 9 of the material composite but also to anchor the backing layer 1, super absorber polymer 10 and SM cover layer 3, 4 one to the other, the latter anchoring effect of the various layers of the material composite resulting in material composites of particularly high strength and thus of particularly high quality.

Referring now to FIGS. 3 and 4 there is illustrated distinctly how a fluid impermeable composite of the backing layer 1 and membrane la in accordance with prior art (FIG. 3) differs from one such material composite of the backing layer I and the hot melt film 9 in accordance with the present invention (FIG. 4), the latter depicting a portion taken from the interface between backing layer 1 and hot melt film 9 magnified not to scale. It is obvious how the film 9, because of it being applied to the backing layer 1 as a hot melt, penetrates into the pores of the backing layer 1 comprising a fiber fleece when applied thereto, resulting in particularly good anchoring between the hot melt film 9 forming the membrane and the backing layer 1.

Referring now to FIG. 5 there is illustrated diagrammatically how the surface of the hot melt film 9 is considerably increased by penetration or sinking of the hot melt film 9 into the pores of the fiber fleece constituting the backing layer 1 whilst simultaneously correspondingly reducing the thickness of the hot melt film 9. This is particularly important where hydrophilic, in other words breathable, materials are employed for creating the hot melt film 9, since it is in this way that the desired particularly high permeability to water vapor is achieved.

Referring now to FIG. 6 there is illustrated in turn in a greatly diagrammatic view an example aspect of a multilayer composite showing the backing layer 1 and the hot melt film 9 having sunk thereinto as depicted diagrammatically. In addition, the multilayer composite as shown in FIG. 6 comprises a cover layer 3, 4 consisting of an SM composite, for example.

Referring now to FIGS. 7 and 8 there is illustrated in each case, part of the membrane formed by the hot melt film 9 and the interfacing surfaces of the backing layer 1 and cover layer 3, 4 comprising an SM composite respectively. It is evident from the aspect as shown in FIG. 7 how the method has been engineered to anchor the hot melt film 9 particularly intimately to the backing layer 1 whilst in the aspect as shown in FIG. 8, again in engineering the method accordingly in producing the composite, a corresponding solid anchoring of the hot melt film 9 to the SM composite 3, 4 is additionally achieved.

Referring now to FIGS. 9 and 10 there is illustrated in turn, again greatly diagrammatically, two aspects for a material composite additionally characterized by the super absorber polymer powder 10 contained in the composite. As shown in FIG. 9 the super absorber polymer powder 10 is embedded substantially completely in the hot melt film 9 whereas in the aspect as shown in FIG. 10 it was simply powdered on the hot melt film 9 whilst still hot and is thus arranged on the surface thereof.

In all, it will thus be appreciated that by virtue of the material web in accordance with the invention and by virtue of the method of producing such a material web in accordance with the invention salient properties such as permeability to water vapor, fluid barrier, strength and wearing comfort of functional and protective clothing or highly absorbent personal care articles, particularly diapers, can now be decisively enhanced with no appreciable increase in, or indeed with a reduction of, the costs of producing material webs in accordance with the invention, despite their improved performance.

1. A flexible fluid-tight material web for protective clothing or personal care articles, out of a two or multi-layer composite fleece backing comprising a porous sheet backing, for example a carrier fleece, where a fluid-tight polymer layer is arranged on said backing in a form-locking and tight-fitting manner, where said fluid-tight polymer layer is a film consisting of a hot melt adhesive open to diffusion and where said material web comprising a powdery super absorber polymer, wherein said super absorber polymer is embedded in said hot melt adhesive.

2. The material web as set forth in claim 1, wherein said hot melt adhesive consists of EVA, PA, PVAL, PUR with or without hydrophilic components.

3. The material web as set forth in claim 1, wherein said hydrophilic component is an elastomer based on polytetramethylene oxide, a comonomer of polypropylene oxide and polyethylene oxide or a hydrophilic polymer plasticizer.

4. The material web as set forth in claim 1, wherein the coating weight of said hot melt adhesive is in the range 5 to 50 g/m².

5. The material web as set forth in claim 1, wherein said porous backing is a PP, PET or PE spunbond or needle-punched fleece, a water consolidated fleece or a microfiber fleece.

6. The material web as set forth in claim 1, wherein said porous backing is a textile fleece having a weight in the range 10 to 150 g/m².

7. The material web as set forth in claim 1, wherein said porous backing is a spunbond fleece of PP, HDPE or LDPE having a weight in the range 10 to 60 g/m².

8. The material web as set forth in claim 1, wherein a cover layer disposed on said hot melt adhesive.

9. The material web as set forth in claim 1, wherein said cover layer is engineered kind to the skin by oily or fatty avivages.

10. The material web as set forth in claim 1, wherein a reinforcement fabric or reinforcement mesh disposed in or on said hot melt adhesive.

11. The material web as set forth in claim 1, wherein said super absorber polymer is covered by a hydrophilic microfiber fleece.

12. The material web as set forth in claim 1, wherein said super absorber polymer is covered by a SM composite of hydrophilic spunbond fleece (PP, HDPE, LDPE) having a weight preferably in the range 8 to 50 g/m² and of a hydrophilic melt blown (PP) having a weight preferably in the range 10 to 100 g/m².

13. The material web as set forth in claim 12, wherein said melt blown is replaced by a textile flaking.

14. The material web as set forth in claim 1, wherein said hot melt adhesive is submerged into interspaces or cavities of said backing fleece and/or covering fleece.

15. The material web as set forth in claim 1, comprising a water vapor permeability higher than 200 g/m²×d at 23° C. and 0%./.85%.

16. A method of producing a flexible fluid-tight material web, containing a powdery super absorber polymer, for protective clothing or personal care articles, where said material web comprises two or more joined layers and including a porous sheet backing including a fluid-tight layer arranged on said backing, said method comprising the steps of
a) applying a still molten polymer film onto said porous backing, where said polymer film consists of a hot melt adhesive open to diffusion; wherein the applying of said polymer film done in step a) is followed by the following method step of:
b) powdering super absorber polymer powder directly onto said still hot melt of said hot melt adhesive;
c) applying a cover layer; and
d) bonding said layers by calandering such that said super absorber polymer powder is embedded in said hot melt adhesive.

17. The method as set forth in claim 16, wherein said cover layer in the method step c) is an SM composite of spunbond fleece and melt blown.

18. The method as set forth in claim 17, wherein said melt blown (3) is replaced by a textile flaking.

19. The method as set forth in claim 16, wherein prior to applying said cover layer in said method step c), a hot melt spray coating is made on the inside of said cover layer.

20. The method as set forth in claim 16, wherein method steps a) to d) are implemented in a continuous inline method.

21. The method as set forth in claim 16, wherein after method step a) a reinforcement fabric or reinforcement mesh is applied within or on said hot melt adhesive.
